(19) United States
(12) Patent Application Publication
(10) Pub. No.: US 2012/0169109 A1
(43) Pub. Date: Jul. 5, 2012

(54) Heated Dump Body

(75) Inventors: Michael Rivera, San Antonio, TX (US); Shriniwas Nayak, San Antonio, TX (US)

(73) Assignee: Trinity Industries, Inc., Dallas, TX (US)

(21) Appl. No.: 13/335,366

(22) Filed: Dec. 22, 2011

Related U.S. Application Data
(60) Provisional application No. 61/428,405, filed on Dec. 30, 2010.

(51) Int. Cl. B60K 13/06; B60H 1/00

(52) U.S. Cl. 298/1 H; 165/41

(57) ABSTRACT

A system and method for heating a dump body is disclosed. In particular embodiments, a heated dump body comprises a floor including one or more bolsters formed within the floor. The dump body further includes a pair of side sheets, each of the side sheets coupled to one side of the floor, each of the pair of side sheets including one or more bolsters formed within each respective side sheet. The dump body further includes a front sheet coupled to the floor and the side sheets, the front sheet including one or more bolsters formed within the front sheet. The dump body also includes a canopy coupled to the front sheet, the canopy including one or more bolsters formed within the canopy. The bolsters formed in the floor, the pair of side sheets, the front sheet and the canopy are each operable to channel air.

### TECHNICAL FIELD OF THE INVENTION

The invention relates generally to construction or mining vehicles, and more particularly to a heated dump body.

### BACKGROUND

Dump bodies are manufactured to fit on trucks of major manufacturing companies. These bodies consist of four basic components. These components include a floor, side sheets, front sheet and canopy. In some extreme weather environments, material can accumulate on portions of a dump body, leading to a costly and inefficient reduction in the amount of material a conventional dump truck may carry.

### SUMMARY OF EMBODIMENTS OF THE DISCLOSURE

In accordance with particular embodiments of the present disclosure, the disadvantages and problems associated with dump bodies have been substantially reduced or eliminated.

In accordance with one embodiment of the present disclosure, a dump body comprises a floor including one or more bolsters formed within the floor. The dump body further includes a pair of side sheets, each of the side sheets coupled to one side of the floor, each of the pair of side sheets including one or more bolsters formed within each respective side sheet. The dump body further includes a front sheet coupled to the floor and the side sheets, the front sheet including one or more bolsters formed within the front sheet. The dump body also includes a canopy coupled to the front sheet, the canopy including one or more bolsters formed within the canopy. The bolsters formed in the floor, the pair of side sheets, the front sheet and the canopy are each operable to channel air.

In accordance with another embodiment of the present disclosure, a method for heating portions of a dump body includes forming one or more bolsters in a floor of a dump body. The method also includes forming one or more bolsters in each of a pair of side sheets of the dump body, each of the pair of side sheets coupled to the floor of the dump body. The method further includes forming one or more bolsters in a front sheet of the dump body, the front sheet coupled to the floor and the side sheets of the dump body. The method also includes forming one or more bolsters in a canopy of the dump body, the canopy coupled to the front sheet and channeling air through the bolsters formed in the floor, the pair of side sheets, the front sheet and the canopy of the dump body.

Embodiments or the present disclosure may substantially reduce or eliminate the accumulation of unwanted material associated with conventional dump trucks or dump bodies. In particular embodiments, bolsters provide for the circulation of heated air throughout a dump body to warm certain surfaces of the dump body. This has the effect of warming material, such as sand, gravel, and dirt, and at least partially prevents it from freezing to the metal of the dump body. Reduction of such carry-back material increases the carrying capacity of subsequent loads, and leads to the improvement of overall efficiency of operations carried out by dump trucks in accordance with embodiments of the present disclosure.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates a heated dump body disposed on a truck according to a particular embodiment of the present disclosure;

FIGS. 2A and 2B illustrate a heated dump body according to a particular embodiment of the present disclosure;

FIG. 3 illustrates a side sheet component of a heated dump body in accordance with particular embodiments of the present disclosure;

FIGS. 4A-4D illustrate components of a dump body in greater detail in accordance with particular embodiments of the present disclosure;

FIG. 5 illustrates air flow through a heated dump body in accordance with particular embodiments of the present disclosure; and

FIG. 6 is a flow diagram illustrating an operation in accordance with particular embodiments of the present disclosure.

### DETAILED DESCRIPTION OF THE INVENTION

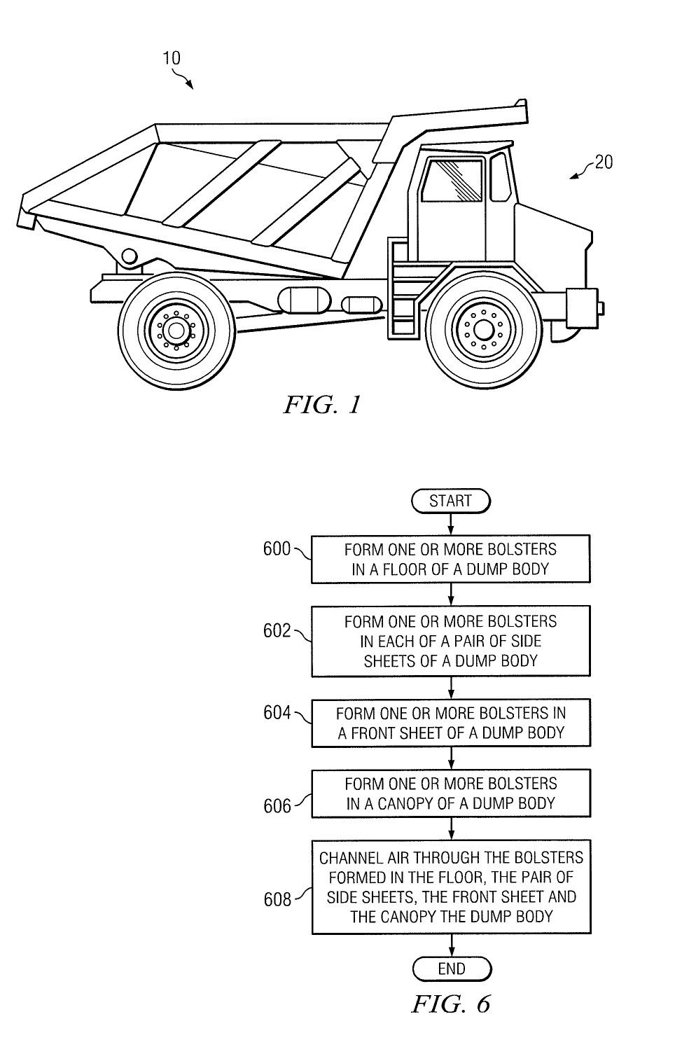

Preferred embodiments of the invention and its advantages are best understood by reference to FIGS. 1-6 wherein like reference numbers indicate like features.

Dump trucks and other various loading or conveying vehicles often need to operate in extreme weather environments. For example, dump trucks may operate in northern latitude environments in which the outside temperature is below freezing for a substantial amount of a dump truck's operating time. In such extreme weather environments, portions of lading or cargo material intended to be conveyed from one location to another may become frozen and stuck to the bed or canopy of a conventional dump truck. Aggregate material, such as sand, gravel, and/or dirt in particular may become frozen in place on portions of a conventional dump truck's bed or canopy. As a result, some material that is placed into a conventional dump truck may not be dumped or removed when the conventional dump truck unloads its lading or cargo, instead remaining frozen to the bed, side walls, or canopy. Over time, more and more frozen material may accumulate in or on the conventional dump truck, leading to less material conveyed with each subsequent load. This may result in a less efficient overall operation.

Particular embodiments of the present disclosure may substantially reduce or eliminate these and other deficiencies. FIG. 1 illustrates a heated dump body 10 in accordance with particular embodiments of the present disclosure. Dump body 10 may be utilized in conjunction with truck 20 in various construction or manufacturing operations to convey material between locations. As an example, truck 20 may represent a six wheel vehicle with one powered rear axle, a ten wheel vehicle with two powered rear axles, a three-axle vehicle with one lift axle and two powered axles, and/or a four-axle vehicle with two lift axles and two powered axles. Truck 20 may also represent a semi-trailer or tractor-trailer with a dump bed for loading and unloading cargo. In general, truck 20 may represent any vehicle suitable to carry dump body 10 and operate dump body 10 to load and unload various types of lading or cargo.

Dump body 10 is operated in conjunction with truck 20 to load, carry, and unload cargo. In particular embodiments, dump body 10 represents an end dump bed, bottom dump or belly dump bed, or side dump bed. Dump body 10 may unload cargo through the operation of one or more hydraulic lifts or gates in a conventional manner.

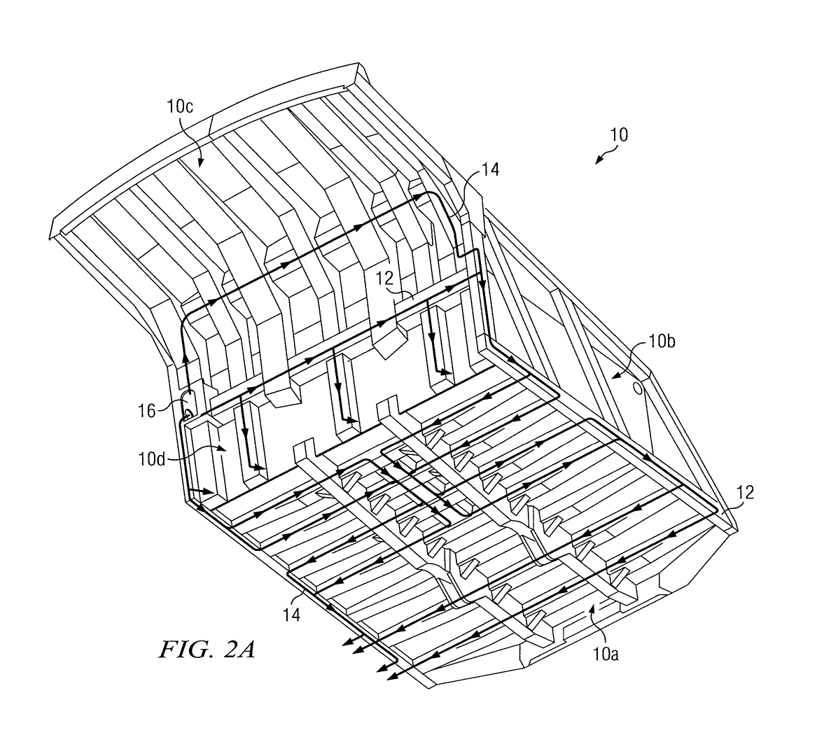

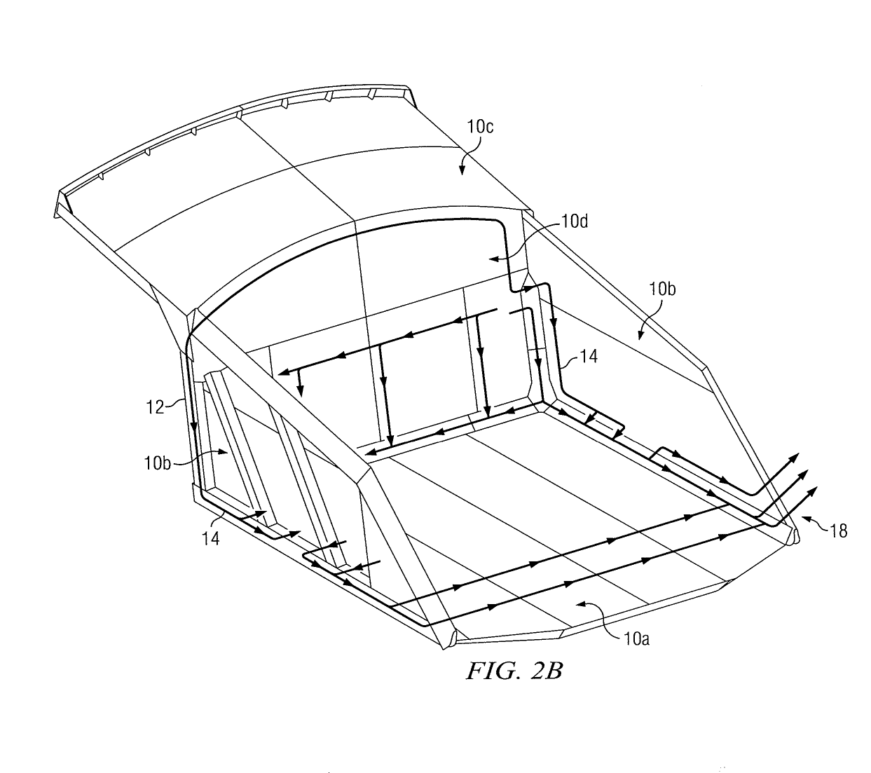

FIGS. 2A and 2B illustrate isometric views of dump body 10 in accordance with particular embodiments of the present disclosure. FIG. 2A represents a bottom view of dump body 10 and FIG. 2B represents a top view of dump body 10. As shown in FIGS. 2A and 2B, dump body 10 includes floor 10a, side sheets 10b, and front sheet 10d which cooperate to keep lading or cargo inside dump body 10 during transport. In some embodiments, dump body 10 includes canopy 10c, which protects a cab of truck 20 from extraneous material as truck 20 is loaded or unloaded. Canopy 10c may be suitably curved in shape to prevent accumulation of aggregate material that falls onto canopy 10c. In particular, as material is loaded into dump body 10, some may inadvertently fall on canopy 10c. A curved shape allows for the extraneous material to fall off during operation rather than accumulate. In particular embodiments, dump body 10 includes one or more bolsters 12. Bolsters 12 represent generally rectangular and hollow channels or passageways formed within floor 10a, side sheets 10b, front sheet 10d and canopy 10c. Bolsters 12 allow air to flow through dump body 10 as shown by arrows 14. Bolsters 12 may be formed from sheet metal, cast iron, or any other appropriate conductive material suitable to transfer heat from air or liquid flowing through bolsters 12 to other portions of dump body 10.

In some embodiments, dump body 10 captures the exhaust of an engine of truck 20 and channels it through one or more bolsters 12 formed within dump body 10. In particular, exhaust air from an engine may be directed through bolsters 12 and pass through dump body 10 rather than be directly expelled through a conventional exhaust system. To receive exhaust from an engine, exhaust intake 16 may be formed within a portion of dump body 10. As shown in FIG. 2A exhaust intake 16 is formed in a right forward portion of dump body 10. In one embodiment, exhaust from an engine flows through bolsters 12 in dump body 12 in a manner illustrated by arrows 14. Although arrows 14 show a particular air flow through dump body 10, it should be understood that bolsters 12, and heated air flowing through them, may be configured or arranged in any appropriate manner suitable to sufficiently heat dump body 10. As shown in FIGS. 2A and 2B, heated air flow into exhaust intake 16, is channeled into bolsters 12 in canopy 10c, bolsters in front sheet 10d, and then flows through bolsters 12 in floor 10a. Once it passes through bolsters 12, heated air may be expelled through exhaust outlet 18 into the ambient environment.

In general, dump body 10 utilizes the thermal energy of heated air as it contacts the interior surfaces of bolsters 12 to heat the metal surfaces of floor 10a, side sheets 10b, front sheet 10d and canopy 10c. In this manner, bolsters 12 operate to conduct heat through one or more of the various surfaces of dump body 10. Warming the metal surfaces of floor 10a, side sheets 10b, front sheet 10d and canopy 10c may substantially reduce the propensity of aggregate material to freeze to dump body 10 in extreme weather environments. This may facilitate the reduction or elimination of any material carry-back (i.e., aggregate material not dumped at an unloading location and carried back to a loading location), thereby providing for maximum subsequent loads.

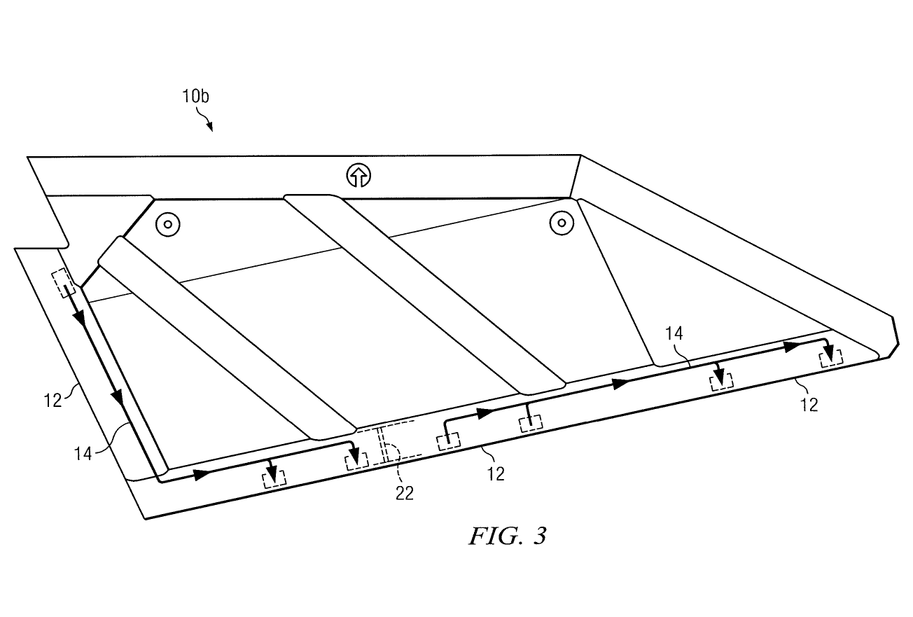

Conventional methods of reducing the accumulation of frozen aggregate material to a dump bed may have led to an inconsistent balance of heat (i.e., between a left side of a dump bed and a right side of a dump bed) and a total absence of heat to a canopy. The inconsistent heat balance allows material to remain in a dump bed after an attempted unloading. Particular embodiments of the present disclosure may include one or more baffles 22 disposed within bolsters 12 to advantageously direct air flow throughout bolsters 12. For example, FIG. 3 illustrates side sheet 10b in which baffle 22 is disposed within bolster 12 formed within a lower edge portion of side sheet 10b. As shown in FIG. 3, baffle 22 redirects heated air (represented by arrow 14) flowing longitudinally through side sheet 10b in a lateral direction toward the interior of floor 10a of dump body 10. Baffles 22 may be located in any suitable location within bolsters 12 to advantageously control or direct the flow of heated air. For example, baffles 22 may direct heated air from exhaust intake 16 toward canopy 10c, from exhaust intake 16 toward side sheets 10b, from canopy 10c toward side sheets 10c, from side sheets 10c toward an interior portion of floor 10a, and/or from floor 10a toward exhaust outlet 18. In general, baffles 22 may facilitate the even distribution of heated air through appropriate portions of dump body 10. In particular embodiments, the precise location and configuration of baffles 22 may depend on the overall shape and configuration of dump body 10 and the shape and configuration of bolsters 12 within dump body 10.

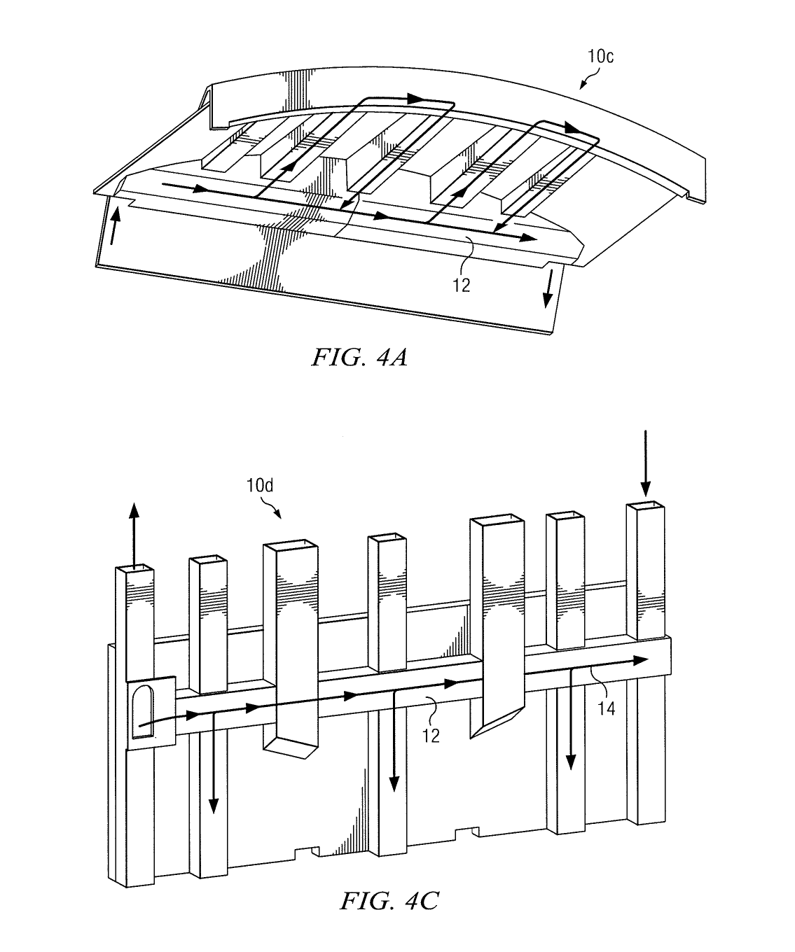

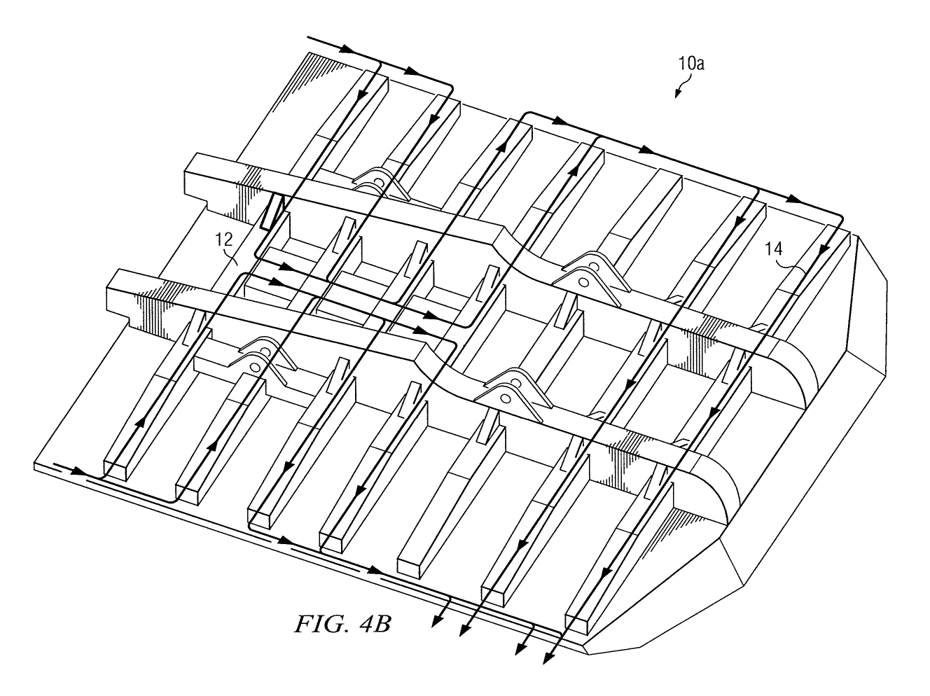

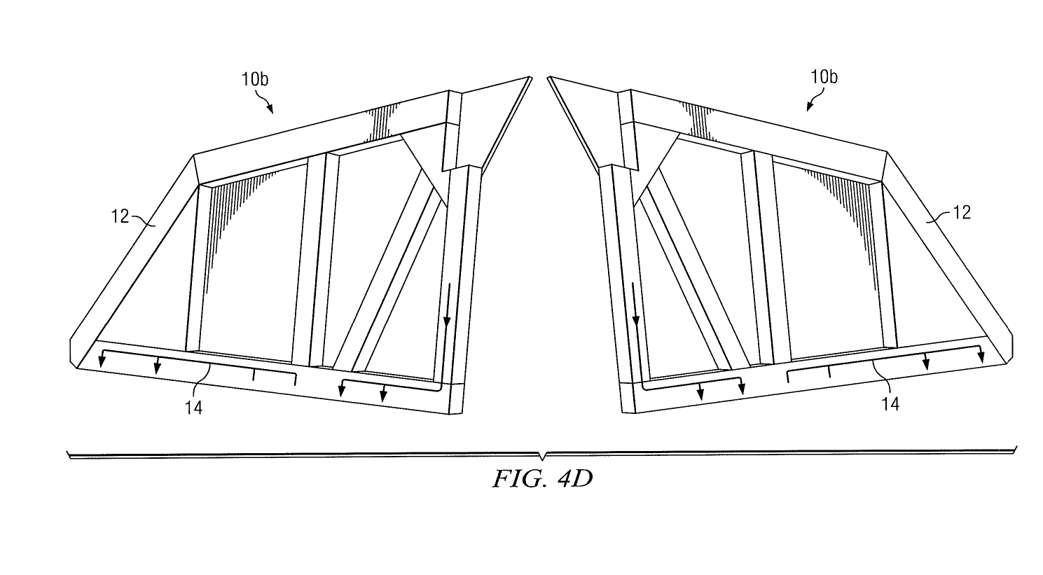

FIGS. 4A-4D illustrate components of dump body 10 in greater detail in accordance with particular embodiments of the present disclosure. For example, FIG. 4A illustrates canopy 10c utilized in particular embodiments. As shown in FIG. 4A, canopy 10c may be coupled to front sheet 10d. Bolsters 12 may carry heated air from front sheet 10d to a rearward portion of canopy 10c, thus reducing or eliminating the amount of material that freezes and collects on canopy 10c. Canopy 10c may be generally convexly curved to facilitate discharge of extraneous aggregate material. As material is loaded into dump body 10, some material may fall on canopy 10c. As canopy 10c is heated to loosen frozen accumulation of material on canopy 10c, the curvature of canopy 10c may allow extraneous material to fall or slough off canopy 10c during routine operation of truck 20. Canopy 10c may include bolster 12 formed within a rearward portion of canopy 10c. Bolster 12 in canopy 10c may be formed within the rearward most 14 inches of canopy 10c, where most of the aggregate material generally falls. Thus, there is the greatest need for heated air flow toward the rearward portion of canopy 10c. In some embodiments, however, canopy 10c may include one or more bolsters 12 that direct heated air toward a center or forward portion of canopy 10c. For example, in some operating environments, aggregate material may accumulate on a forward edge portion or center portion of canopy 10c. Bolsters 12 located in these areas may reduce or prevent the accumulation of aggregate material throughout canopy 10c. In some embodiments, canopy 10c may be sloped downward toward the rear of dump body 10. Such configuration may allow condensation that collects within bolsters 12 in canopy 10c to flow down and away from canopy 10c. A sloped configuration may further allow accumulated material to fall into the bed of dump body 10 while dump body 10 is unloading, thereby increasing the amount of material actually delivered to the dumping or unloading site.

FIG. 4B shows floor 10a of dump body 10 in greater detail. Floor 10a may couple to side sheets 10b and front sheet 10d. In some embodiments, floor 10a includes one or more bolsters 12 extending at least partially down the center of floor 10a. One or more bolsters 12 may connect to and extend laterally away from a center bolster 12 to channel air flow through portions of floor 10a. One or more bolsters may also be formed along a side portion of floor 10a.

FIG. 4C shows front sheet 10d in greater detail. Front sheet 10d is coupled to floor 10a, side sheets 10b and canopy 10c. In some embodiments front sheet 10d includes one or more horizontal bolsters 12 that channel air flow laterally across front sheet 10d. Vertical bolsters 12 may be connected to one or more horizontal bolsters 12 and channel air flow through upper and lower portions of front sheet 10d.

FIG. 4D shows side sheets 10b in greater detail. Side sheets 10b may be coupled to floor 10a, front sheet 10d and canopy 10c. In particular embodiments side sheets 10b may include one or more vertical, horizontal and/or oblique bolsters 12 to channel air flow through portions of side sheets 10b.

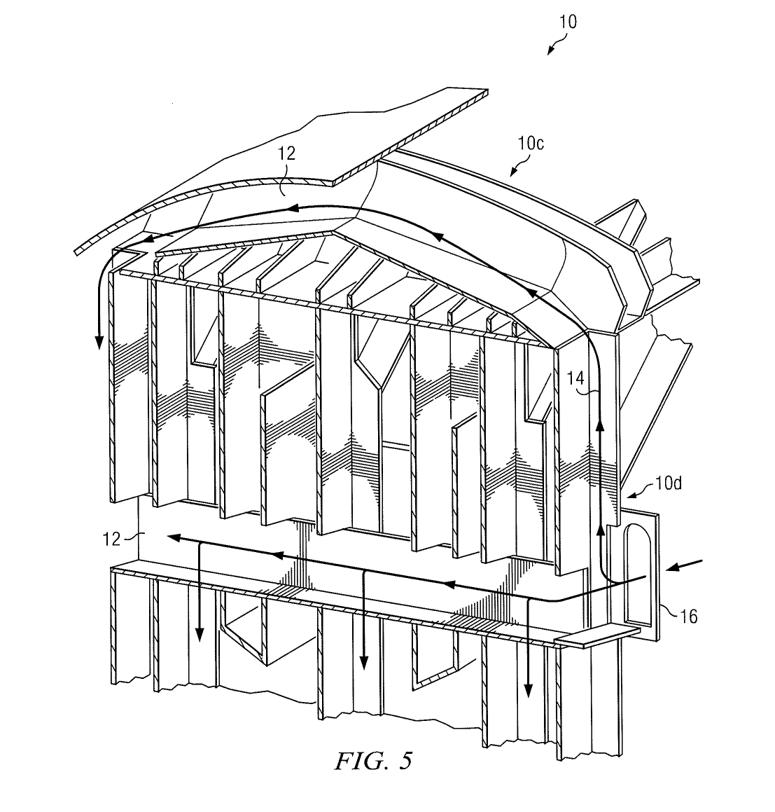

FIG. 5 shows air flow through bolster 12 in front sheet 10d and canopy 10c. In particular embodiments, one or more bolsters 12 in front sheet 10d may receive air from an exhaust system of truck 20 through exhaust inlet 16. Heated air may flow upward through bolsters 12 and toward a top portion of canopy 10c. In some embodiments, longitudinally formed bolsters 12 within canopy 10c may channel air through a forward portion of canopy 10c. In other embodiments, heated air flows through bolster 12 transversely positioned along a rearward section of canopy 10c (i.e., closest to a bed of dump body 10), thus heating only a rearward portion of canopy 10c

Performance of embodiments of the present disclosure may be further enhanced through the addition of one or more additional features. For example, heated air flow through bolsters 10 may be advantageously assisted in particular embodiments of dump body 10 through the use of blowers. For example, depending on the size of dump body 10 and/or the overall course of air flow through bolsters 10, the pressure of exhaust gas from an engine of truck 20 may not be sufficiently powerful to suitably heat all desired sections of dump body 10. A blower motor may therefore be positioned in an advantageous location within bolsters 12 to assist in air flow. A blower may be manually activated by a driver or other user, and may be positioned within a particular bolster 12 or proximate to an exhaust system of truck 20. A blower may equalize flow and/or distribution of heated exhaust air to maximize the heat transfer throughout dump body 10.

As another example, in some extreme weather environments, it may be desirable to further reduce heat loss through bolsters 12. Thus, in some embodiments, an insulating paint may be applied to inner and/or outer surfaces of bolsters 12 to inhibit heat loss to ambient air. Insulating paint applied to bolsters 12 may reduce heat loss to the ambient air, thus providing more efficient heat transfer to floor 10a, side sheets 10b, canopy 10c, front sheet 10d, and/or other components of dump body 10, providing for more effective reduction of accumulated frozen material.

As another example, particular embodiments of dump body 10 may include ducting and/or piping disposed within bolsters 12. Ducting and/or piping may carry a freeze-resistant liquid that passes through a heat exchanger of an engine to absorb heat from an exhaust system. Ducting and/or piping may be positioned within bolsters 12 proximate to a surface of floor 10a, side sheets 10b, canopy 10c, front sheet 10d, and/or other components of dump body 10 to transfer heat to an outer surface of dump body 10. Ducting and/or piping may then return cooled liquid to the heat exchanger where it may be reheated for return flow through bolsters 12. Liquid flowing through a ducting and/or piping system within bolsters 12 may be a bio-friendly liquid that operates at temperatures appropriate for an extreme weather environment.

As another example, particular embodiments of dump body 10 may include one or more auxiliary heat sources that may be utilized in addition to or in lieu of an exhaust system of truck 20. Auxiliary heat sources may heat portions of dump body 10 by channeling air through bolsters 12. For example, particular embodiments of dump body 10 may include one or more internal electrical heating element pads and/or blankets attached to one or more bolsters 12, floor 10a, side sheets 10b, canopy 10c, front sheet 10d and/or other components of dump body 10. Heating element pads and/or blankets may be connected to and/or powered by an electrical system of truck 20. An auxiliary heat source may additionally or alternatively include a heat source, such as, for example, a kerosene heater, that uses a fuel source to heat air and, utilizing a blower, propel heated air through bolsters 12. An auxiliary heat source provides the additional benefit of reducing corrosion within dump body 10 and/or bolsters 12. For example, in some embodiments, back pressure to the exhaust system an engine of truck 20 (due to the resistance to air flow through bolsters 12) and corrosion of bolsters 12 and/or welds of dump body 10 from exhaust flowing through bolsters 12 may reduce the advantages and desirability of channeling hot exhaust air through dump body 10. In some embodiments, an auxiliary source of heat may be isolated from an engine exhaust source and thus reduce relevant back pressure and corrosion and provide a more advantageous solution.

To reduce or eliminate corrosion caused by corrosive exhaust gases flowing through bolsters 12, some embodiments of dump body 10 may include a corrosion resistant paint applied to the interior of bolsters 12. Over time, exhaust and moisture traveling through bolsters 12 may combine to corrode portions of bolsters 12 and/or other components of dump body 10. A corrosion resistant paint and/or other material applied to the interior of bolsters 12 may reduce or eliminate the corrosion caused by exhaust and moisture. In some embodiments, a corrosion resistant paint may be applied after welds applied to one or more bolsters are formed. Thus, corrosion resistant paint may be applied to the interior of bolsters 12 after bolsters 12 are welded together.

FIG. 6 is a flow diagram illustrating a particular operation in accordance with particular embodiments of the present disclosure. At step 600, one or more bolsters are formed in a floor of a dump body. During manufacture, bolsters 12 may be formed in floor 10 of a dump body 10 in accordance with particular embodiments of the present disclosure. For example, bolsters may be formed in floor 10a of a dump body as shown in FIGS. 2A and 4B.

At step 602, one or more bolsters are formed in each of a pair of side sheets of a dump body. Each of the pair of side sheets may be coupled to the floor of the dump body. During manufacture, bolsters 12 may be formed in side sheets 10b of dump body 10 in accordance with particular embodiments of the present disclosure. For example, side sheets 10b may be manufactured with bolsters 12 included in the locations as shown in FIGS. 2A, 2B, 3 and 4D. Side sheets 10b may be coupled to floor 10a through any appropriate method or device, such as, for example, by welding, bolts, or forming an integrated floor and side sheets.

At step 604, one or more bolsters are formed in a front sheet of a dump body. The front sheet may be coupled to the floor and the side sheets of the dump body. During manufacture, bolsters 12 may be formed in side sheets 10d of dump body 10 in accordance with particular embodiments of the present disclosure. Front sheet 10d may be coupled to floor 10a and side sheets 10b through any appropriate method or device, such as, for example, by welding, bolts or other fasteners, and/or forming front sheet 10d integral with floor and side sheets.

At step 606, one or more bolsters are formed in a canopy of the dump body. The canopy may be coupled to the front sheet. During manufacture, bolsters 12 may be formed in canopy 10c of dump body 10 in accordance with particular embodiments of the present disclosure. For example, canopy 10c may be manufactured with bolsters 12 included in the locations as shown in FIGS. 2A, 2B, 4A and 5. Canopy 10c may be coupled to side sheets 10b and/or front sheet 10d through any appropriate method or device, such as, for example, by welding, bolts or other fasteners, and/or forming canopy 10c integral with front sheet 10d and side sheets 10b.

At step 608 air may be channeled through the bolsters formed in the floor, the pair of side sheets, the front sheet and the canopy of the dump body. In particular embodiments, bolsters 12 may be coupled to an exhaust system of truck 20, and may channel heated air from the exhaust system through one or more bolsters. Bolsters 12 may form one continuous channel throughout dump body 10 for heated exhaust air to flow.

The steps illustrated in FIG. 6 may be combined, modified, or deleted where appropriate, and additional steps may also be added to those shown. Additionally, the steps may be performed in any suitable order without departing from the scope of the present disclosure.

Although several embodiments of the present disclosure have been described with particularity, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A dump body comprising:
a floor including one or more bolsters formed within the floor;
a pair of side sheets, each of the side sheets coupled to one side of the floor, each of the pair of side sheets including one or more bolsters formed within each respective side sheet;
a front sheet coupled to the floor and the side sheets, the front sheet including one or more bolsters formed within the front sheet;
a canopy coupled to the front sheet, the canopy including one or more bolsters formed within the canopy; and
wherein the bolsters formed in the floor, the pair of side sheets, the front sheet and the canopy are each operable to channel air.

2. The dump body of claim 1, further comprising an exhaust intake formed in at least one bolster, the exhaust intake coupled to an exhaust system of an engine of a truck carrying the dump body.

3. The dump body of claim 2, wherein exhaust air from the exhaust system flows through the exhaust intake and into a continuous channel formed by the bolsters in the floor, the pair of side sheets, the front sheet, and the canopy.

4. The dump body of claim 1, wherein the canopy is formed in a convexly curved shape and operable to facilitate shedding of aggregate material.

5. The dump body of claim 1, wherein the canopy includes a bolster operable to channel air laterally along a rearward section of the canopy.

6. The dump body of claim 5, wherein the canopy includes a bolster operable to channel air longitudinally toward a forward section of the canopy.

7. The dump body of claim 1, further comprising a blower operable to assist air flow through the one or more bolsters.

8. The dump body of claim 1, wherein a corrosion resistant paint is applied to the interior of at least one of the one or more bolsters.

9. The dump body of claim 1, wherein an insulating paint is applied to the exterior of at least one of the one or more bolsters.

10. The dump body of claim 1, further comprising a ducting system disposed within the one or more bolsters operable to circulate a liquid through the dump body.

11. The dump body of claim 1, further comprising:
an auxiliary heat source operable to heat air; and
a blower operable to circulate the air heated by the auxiliary heat source through the one or more bolsters formed in the floor, the side sheets, the front sheet, and the canopy of the dump body.

12. The dump body of claim 11, wherein the auxiliary heat source comprises a kerosene heater.

13. A method for heating portions of a dump body comprising:
forming one or more bolsters in a floor of a dump body;
forming one or more bolsters in each of a pair of side sheets of the dump body, each of the pair of side sheets coupled to the floor of the dump body;
forming one or more bolsters in a front sheet of the dump body, the front sheet coupled to the floor and the side sheets of the dump body;
forming one or more bolsters in a canopy of the dump body, the canopy coupled to the front sheet; and
channeling air through the bolsters formed in the floor, the pair of side sheets, the front sheet and the canopy of the dump body.

14. The method of claim 13, further comprising:
forming an exhaust intake in at least one bolster; and
coupling the exhaust intake to an exhaust system of an engine of a truck carrying the dump body.

15. The method of claim 14, further comprising allowing exhaust air from the exhaust system through the exhaust intake and into a continuous channel formed by the bolsters in the floor, the pair of side sheets, the front sheet, and the canopy.

16. The method of claim 13, further comprising forming the canopy in a convexly curved shape to facilitate shedding of aggregate material.

17. The method of claim 13, wherein channeling air through the bolsters formed in the canopy of the dump body comprises channeling air through one or more bolsters formed laterally along a rearward section of the canopy.

18. The method of claim 17, wherein channeling air through the bolsters formed in the canopy of the dump body further comprises channeling air longitudinally toward a forward section of the canopy.

19. The method of claim 13, further comprising assisting air flow through the bolsters with a blower.

20. The method of claim 13, further comprising applying a corrosion resistant paint to the interior of at least one of the one or more bolsters.

21. The method of claim 13, further comprising applying an insulating paint to the exterior of at least one of the one or more bolsters.

22. The method of claim 13, further comprising forming a ducting system within the one or more bolsters operable to circulate a liquid through the dump body.

23. The method of claim 13, further comprising:
heating air with an auxiliary heat source; and
circulating the air heated by the auxiliary heat source through the one or more bolsters formed in the floor, the side sheets, the front sheet, and the canopy of the dump body.

24. The method of claim 23, wherein the auxiliary heat source comprises a kerosene heater.
